(19) United States
(12) Patent Application Publication
(10) Pub. No.: US 2008/0092639 A1
(43) Pub. Date: Apr. 24, 2008

(54) Apparatus And Methods For Controlling Flow In Liquid Chromatography

(76) Inventor: Dian Y. Lee, Hockessin, DE (US)

Correspondence Address: Pepper Hamilton LLP, 400 Berwyn Park, 899 Cassatt Road, Berwyn, PA, 19312-1183, US

(21) Appl. No.: 11/550,925

(22) Filed: Oct. 19, 2006

(51) Int. Cl. G01N 30/00

(52) U.S. Cl. 73/61.52; 73/198; 73/53.01

(57) ABSTRACT

The present invention provides apparatus and methods for controlling liquid chromatography flow, while preserving optimum separation of analyte components and providing a longer time for detector analysis to simultaneously increase detection sensitivity and resolution.

### FIELD OF THE INVENTION

The present invention is directed, in part, to liquid chromatography, and in particular to methods and apparatus for controlling liquid chromatography flow.

### BACKGROUND OF THE INVENTION

Prior to the 1970's, few reliable chromatographic methods were commercially available to the laboratory scientist. During the 1970's, most chemical separations were carried out using a variety of techniques including open-column chromatography, paper chromatography, and thin-layer chromatography. These chromatographic techniques, however, were inadequate for quantification of compounds and resolution between similar compounds. During this time, pressure liquid chromatography began to be used to decrease flow-through time, thus reducing purification times of compounds being isolated by column chromatography. However, flow rates were inconsistent, and the question of whether it was better to have constant flow rate or constant pressure was debated.

High pressure liquid chromatography (HPLC) was developed in the mid-1970's and quickly improved with the development of column packing materials and the additional convenience of on-line detectors. In general, HPLC is used to separate components of a mixture by using a variety of chemical interactions between the substance being analyzed (analyte) and the chromatography column. The analyte is forced through a column of the stationary phase by introducing a liquid at high pressure. Use of pressure gives the components less time to diffuse within the column, leading to improved resolution in the resulting chromatogram. Solvents used include any miscible combination of water or various organic liquids, the most common being methanol and acetonitrile. Water may contain buffers or salts to assist in the separation of the analyte components, or compounds such as trifluoroacetic acid.

In the late 1970's, new methods including reverse phase liquid chromatography allowed for improved separation between very similar compounds, and by the 1980's HPLC was commonly used for the separation of chemical compounds. Modern HPLC has many applications including separation, identification, purification, and quantification of various compounds. Computers and automation have added to the convenience of HPLC, and the past few decades have seen a vast undertaking in the development of the micro-columns and other specialized columns which have yielded improved results.

There has been a mis-match between HPLC (High performance liquid chromatography) and its detection systems. HPLC has its optimum flow rates to obtain the best separation. A mathematical approximation of the behavior of chromatographic column efficiency is obtained from the van Deemter equation:

H=A+B/u+Cu,

where H is the plate height, u is the linear velocity of the mobile phase, A is the eddy diffusion term, B is the longitudinal diffusion coefficient, and C is the coefficient of the mass transfer term. For given HPLC column, an optimum mobile phase flow rate can be predicted. Departing from the optimum flow rates will result in degradation in separation efficiency. Column and other parameters determine this optimum flow rate. From the standpoint of separation, the faster the separation the better productivity will be gained.

However, the detectors that detect the eluting peaks may not have enough time to effectively detect/process the eluting peaks, especially when the peak width is getting smaller with faster separation in HPLC columns. During the history of HPLC instrumentation development, various detectors have been developed to match with HPLC flow rates. In order to extract more information or gain higher sensitivity, some time-critical detectors such as mass spectrometers (MS), radioactivity detector, NMR, etc. would prefer longer duration for the peak elution.

A normal HPLC peaks can be as short as few seconds in width. A MS analyzer would enjoy higher sensitivity with longer elution time for peaks, especially for structural elucidation of molecules (U.S. Pat. No. 6,139,734). In order to obtain detailed structural information of a peak, a longer time is required. If the detectors require longer time, the detector requires the elution of peaks slow down for better results such as sensitivity.

Besides the detection technology that requires longer peak elution time, a slower flow peak elution flow rate is also desired for some peak processing techniques, such as 2D HPLC. If the second separation has lower optimum flow rate, then it is desired to slow down the LC flow rate. This mis-match demands the slower flow rates from HPLC. Simply slowing down the flow rate during the entire gradient would depart from the optimum flow rate based on van Deemter theory. In the past decades, various techniques referred to as peak parking have been developed to slow down the peak elution time when a peak is detected to solve this flow rate mis-match problem.

Pre-column pressure reduction methods (U.S. Pat. No. 6,139,734; Davis et al., Anal. Chem., 1995, 67, 4549-4556; and Davis et al., J. Amer. Soc. Mass. Spectrom., 1997, 8, 1059-1069) were developed to park peaks. This sudden reduction of pump pressure and low pressure in HPLC column would degrade the separation efficiency of later eluting peaks. Further, it is important to maintain column pressure (Macko et al., J. Liq. Chromtography Rel. Tech., 2001, 24, 1275-1293). Sudden fluctuation of column pressure affects many aspects of LC separation and retention behaviors of components inside the LC column. Therefore, maintaining a constant pressure while performing peak parking is critical to preserve the separation and retention properties of later eluting peaks.

A post-column pressure reduction method (U.S. Pat. No. 6,139,734; and Martin et al., Anal. Chem., 2000, 72, 4266-4274) using a splitter has been attempted. However, those methods have the same disadvantages as the pre-column pressure reduction method since they do not preserve the column pressure during the peak parking period. A part of the sample would be wasted during this splitting process as well.

A post-column peak collection method (U.S. Pat. No. 6,402,946) was developed for collecting peak(s) and feeding the collected peaks to an NMR detector with a slower flowrate. This method did not preserve the column pressure and the time for peak parking would be limited due to the limitation of number of available collection loops.

A stopped flow peak parking method (U.S. Pat. No. 6,858,435) was developed to overcome the above disadvantages recently. This method uses a second pump, for example, to feed a portion of the peak residing between a switching valve and the outlet at the MS detector at a lower flow rate. This method requires intensive instrumentation and only a part of the peak is utilized during the peak parking experiment. The portion of the peak that resides before the switching valve would be wasted. Furthermore, split peaks are observed before and after peak parking occurs due the different solvent delivered by the second pumping system.

All these apparatus and methods have not fundamentally solved the mismatch problem between separation and detection processes due to their disadvantages. Thus, there is a need for a better system that can preserve optimum separation in HPLC column and give longer time for down stream detector when needed. The system also allows the analysis of the entire peak and no parts of peaks being wasted.

The present invention provides such apparatus and methods for implementing the goals described above.

### SUMMARY OF THE INVENTION

The present invention provides an apparatus comprising a pump, a separator in fluid communication with the pump, a flow restrictor in fluid communication with the separator, and a flow sensor, wherein the flow restrictor comprises one input port and one output port.

In some embodiments, the separator is a liquid chromatography column, a high pressure liquid chromatography column, a capillary column, a nano liquid chromatography column, or a reverse phase high pressure liquid chromatography column, or any subgroup thereof. In some embodiments, the flow restrictor is a needle valve. In some embodiments, the flow sensor is a nanoflow sensor.

In some embodiments, the present invention further comprises a detector in fluid communication with the flow restrictor. The detector is a mass spectrometer, a nuclear magnetic resonance detector, a radioactivity detector, an ultraviolet detector, or an electrochemical detector, or any subgroup thereof.

In some embodiments, the present invention further comprises a controller in electronic communication with the pump, flow restrictor, flow sensor, detector, or any combination thereof. In some embodiments, the controller is a microprocessor and/or computer software.

In some embodiments, the present invention further comprises a stepper motor attached to the flow restrictor. The stepper motor is optionally in electronic communication with the controller. In some embodiments, the stepper motor activates or de-activates the flow restrictor.

The present invention also provides methods for detecting an analyte comprising passing a mobile phase comprising the analyte to a separator at a first pump flow rate, passing the mobile phase from the separator to a flow restrictor, wherein the separator is in fluid communication with the flow restrictor, passing the mobile phase from the flow restrictor to a detector at a first restrictor flow rate, wherein the detector is in fluid communication with the flow restrictor, and decreasing the first restrictor flow rate to a second restrictor flow rate upon reaching a first detection event. The separator, flow restrictor, and detector can be any of those described herein.

In some embodiments, the first detection event is a first predetermined time, detection of the beginning of a peak from the analyte by the detector, or a user determined manual adjustment. In some embodiments, decreasing the first restrictor flow rate to the second restrictor flow rate upon reaching the first detection event is affected by activation of the flow restrictor. In some embodiments, upon reaching the first detection event, the detector signals a controller, which is in electronic communication with the detector and flow restrictor, whereby the controller signals the flow restrictor to decrease the first restrictor flow rate to the second restrictor flow rate. In some embodiments, the second restrictor flow rate is less than about 25%, 10%, 1%, 0.1%, or 0.01% of the first restrictor flow rate. In some embodiments, the second restrictor flow rate is measured by a flow sensor.

In some embodiments, the methods further comprise diverting an amount of eluant from the separator to a second separator. In some embodiments, the diversion of an amount of eluant to the second separator is initiated by the detector sending a signal to a controller, which is in electronic communication with the detector, separator, and second separator, upon reaching the first detection event. In some embodiments, the eluant from the separator is diluted with a second mobile phase prior to diverting the eluant to the second separator. In some embodiments, the second separator is, for example, a 2-dimensional high pressure liquid chromatography column.

In some embodiments, the methods further comprise decreasing the first pump flow rate of the mobile phase to the separator to a second pump flow rate. In some embodiments, the pressure in the separator remains substantially steady after the flow restrictor decreases the first restrictor flow rate to the second restrictor flow rate and the pump decreases the first pump flow rate to the second pump flow rate. According to some embodiments, decreasing the first restrictor flow rate of the mobile phase to the second restrictor flow rate upon reaching a first detection event occurs simultaneously with or within 0 to 5 seconds of decreasing the first pump flow rate of the mobile phase to the separator to the second pump flow rate.

In some embodiments a pump is in fluid communication with the separator and comprises the mobile phase for passing into the separator, and wherein upon reaching the first detection event, the detector signals a controller, which is in electronic communication with the detector, flow restrictor, and the pump, whereby the controller signals the flow restrictor to decrease the first restrictor flow rate to the second restrictor flow rate, and whereby the controller signals the pump to decrease the first pump flow rate to the second pump flow rate.

In some embodiments, the methods further comprise increasing the second restrictor flow rate back to about the first restrictor flow rate upon reaching a second detection event. In some embodiments, increasing the second restrictor flow rate back to about the first restrictor flow rate upon reaching the second detection event is affected by de-activation of the flow restrictor. In some embodiments, the second detection event is a second predetermined time, detection of the end of a peak from the analyte by the detector, or a user determined manual adjustment.

Some embodiments provide for a method wherein upon reaching the second detection event, the detector signals a controller, which is in electronic communication with the detector and flow restrictor, whereby the controller signals the flow restrictor to increase the second restrictor flow rate back to about the first restrictor flow rate.

In some embodiments, the methods further comprise increasing the second pump flow rate of the mobile phase to the separator back to about the first pump flow rate. In some embodiments, a pump is in fluid communication with the separator and comprises the mobile phase for passing into the separator, and upon reaching the second detection event, the detector signals a controller, which is in electronic communication with the detector, flow restrictor, and the pump, whereby the controller signals the flow restrictor to increase the second restrictor flow rate back to about the first restrictor flow rate, and whereby the controller signals the pump to increase the second pump flow rate back to about the first pump flow rate.

### BRIEF DESCRIPTION OF THE DRAWINGS

FIG. 1 illustrates a flow control system for controlling LC flow.

FIG. 2 illustrates a flow restrictor at an open (activated) position which allows mobile phase flow through without significant flow resistance.

FIG. 3 illustrates a flow restrictor at restricted (deactivated) position which allows mobile phase flow with substantially higher flow resistance.

FIG. 4 illustrates pressure distribution at various locations under normal flow mode.

FIG. 5 illustrates pressure distribution at various locations of the present invention under restricted flow mode.

FIG. 6 illustrates an HPLC chromatogram showing an analyte under normal flow mode. The peak width at half height was 10 seconds and the LC flow rate was 1 ml/min.

FIG. 7 illustrates an HPLC chromatogram showing the same analyte as in FIG. 6 being eluted at low flow mode. The flow rate was 5 μl/min and the peak width was extended to 616 seconds, a >60 times increase in elution time comparing to normal flow mode.

### DESCRIPTION OF EMBODIMENTS

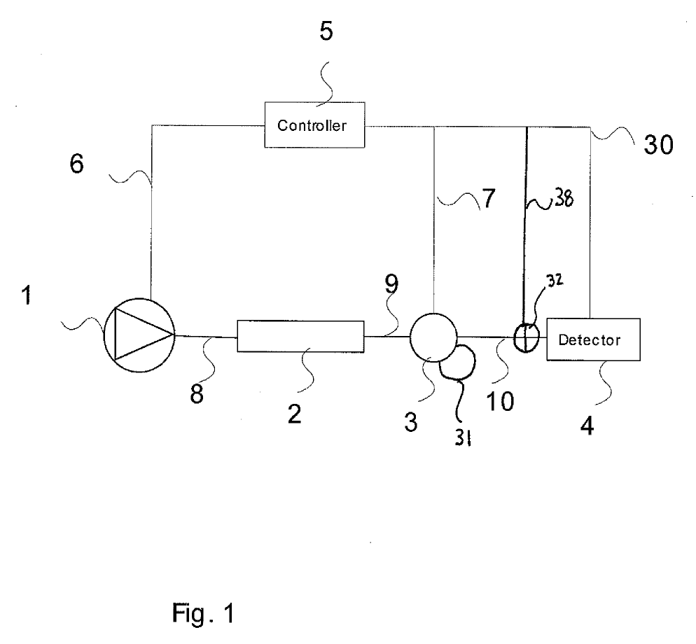

The present invention provides apparatus for controlling LC flow to optimize detection sensitivity and resolution by maintaining column pressure. FIG. 1 illustrates a representative flow control system for controlling LC flow according to an embodiment of the present invention. The apparatus comprises a pump (1), a separator (2), a flow restrictor (3), and a flow sensor (32).

In some embodiments of the present invention, the pump (1) is of the type known to one of ordinary skill in the art. Any pump that can force a mobile phase through a separator (2) can be used.

In some embodiments of the present invention, the separator (2) is a liquid chromatography column, a high pressure liquid chromatography column, a capillary column, a nano liquid chromatography column, a reverse phase high pressure liquid chromatography column, or any subgroup thereof. The separator (2) is in fluid communication via connector (8) with the pump (1). An analyte to be separated can be present within the mobile phase within the pump (1) or can be delivered to the separator (2) via a sample injector (not shown). The separation of analyte components in the separator (2) is governed by van Deemter theory; for a column with particular dimensions and characteristics, an optimum flow rate can be predicted. Some embodiments of the present invention further comprise more than one separator (2). Separator (2) can be a stainless tube packed with fine particles (e.g., 5 μm in diameter) which have different surface characteristics (e.g., C18 chains) or any other commercially available column.

Referring to FIG. 1, flow restrictor (3) is in fluid communication via connector (9) with the separator (2), wherein the flow restrictor (3) comprises only one input port and only one output port. In some embodiments of the present invention, the flow restrictor (3) is a needle valve. In some embodiments, the flow restrictor (3) is an On/Off needle valve. A suitable On/Off valve can be obtained from Valco (part number: ASFVO, Houston, Tex.).

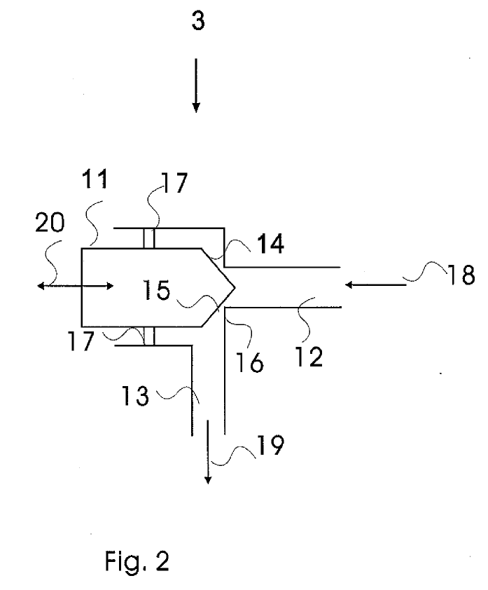

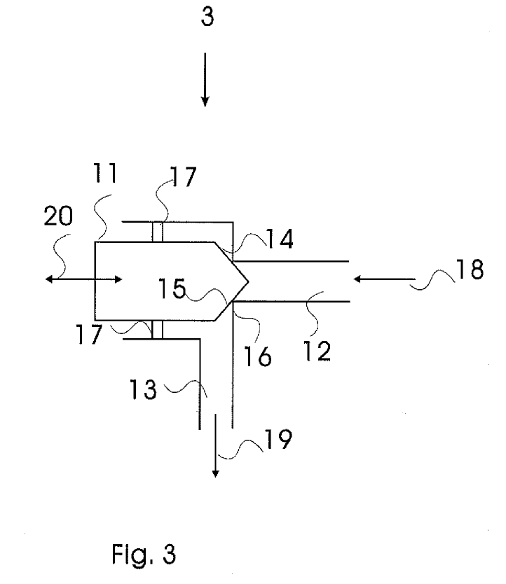

FIGS. 2 and 3 illustrate the internal structures of a representative flow restrictor (3). The flow restrictor (3) comprises fluid inlet (12) with liquid flow direction at restrictor inlet (18), outlet (13), restrictor body (16), needle (11), and seal (17). The opening space (15) between needle body (16) and needle head surface (14) controls the flow resistance. Needle (11) can be adjusted on direction (20) to create a larger opening so that flow though on direction (19) without encountering significant resistance (e.g., <10 psi). This open position or activated position is used for the flow mode of the system. As shown in FIG. 3, a much smaller opening can be created by fine adjustment of needle (11) toward the needle body (16) so that the flow restrictor (3) can create a large flow resistance.

Flow sensor (32) can be any sensor known to those skilled in the art including any commercially available sensor. The flow sensor (32) measures flow rates of the mobile phase and can be positioned as desired by the user of the system depending upon which flow rate is desired to be measured. In FIG. 1, the flow sensor (32) is positioned in fluid communication with the outlet (13) of the flow restrictor (3). This position is only exemplary. In some embodiments, the flow sensor (32) is a nanoflow sensor.

In some embodiments, the apparatus further comprises a detector (4) in fluid communication via connector (10) with the flow restrictor (3). Referring to FIG. 1, flow sensor (32) is located within connector (10). The connectors (8), (9), and (10) can be any type of tubing, such as stainless steel tubing, compatible with LC which can pass fluid from one element within the system to another element within the system. In some embodiments, the detector (4) is a mass spectrometer, a nuclear magnetic resonance detector, a radioactivity detector, an ultraviolet detector, an electrochemical detector, or any subgroup thereof.

In some embodiments, the apparatus further comprises a controller (5) in electronic communication via connectors (6), (7), (38), and (30) respectively, with the pump (1), flow restrictor (3), flow sensor (32), and optionally detector (4). In some embodiments, the controller (5) is a microprocessor and/or computer software.

According to some embodiments, the apparatus further comprises a stepper motor (31) attached to the flow restrictor (3), wherein the stepper motor (31) is optionally in electronic communication with the controller (5). In some embodiments, the stepper motor (31) is attached to the handle (not shown) of the flow restrictor (3). The stepper motor (31) activates or de-activates the flow restrictor (3). The fine adjustment of needle (11) is accomplished by the use of the stepper motor (31) which is programmed to adjust the opening (15).

The embodiments of the apparatus described above can be combined in any manner. Thus, features from one embodiment can be combined with features from any other embodiment. For example, the embodiments described above can be combined in a manner to produce an apparatus comprising: a pump (1); a separator (2) in fluid communication with the pump (1), wherein the separator (2) is a liquid chromatography column, a high pressure liquid chromatography column, a capillary column, a nano liquid chromatography column, or a reverse phase high pressure liquid chromatography column; a flow restrictor (3) in fluid communication with the separator (2), wherein the flow restrictor (3) is a needle valve comprising only one input port (12) and only one output port (13); a nanoflow sensor (32) in fluid communication with the flow restrictor; and a detector (4) in fluid communication with the flow restrictor (3), wherein the detector (4) is a mass spectrometer, a nuclear magnetic resonance detector, a radioactivity detector, an ultraviolet detector, or an electrochemical detector. Such an apparatus may further comprise a controller (5) in electronic communication with the pump (1), flow restrictor (3), flow sensor (32), and detector (4), wherein the controller (5) is a microprocessor and/or computer software. Such an apparatus may further comprise a stepper motor (31) attached to the flow restrictor (3), wherein the stepper motor (31) is in electronic communication with the controller (5).

The embodiments described above can also be combined in a manner to produce an apparatus comprising, for example: a pump (1); a separator (2) in fluid communication with the pump (1), wherein the separator (2) is a liquid chromatography column, a high pressure liquid chromatography column, a capillary column, a nano liquid chromatography column, or a reverse phase high pressure liquid chromatography column; a flow restrictor (3) in fluid communication with the separator (2), wherein the flow restrictor (3) is a needle valve comprising only one input port (12) and only one output port (13); a nanoflow sensor (32) in fluid communication with the flow restrictor; a detector (4) in fluid communication with the flow restrictor (3), wherein the detector (4) is a mass spectrometer, a nuclear magnetic resonance detector, a radioactivity detector, an ultraviolet detector, or an electrochemical detector; and a controller (5) in electronic communication with the pump (1), flow restrictor (3), flow sensor (32), and detector (4), wherein the controller (5) is a microprocessor and/or computer software. Such an apparatus may further comprise a stepper motor (31) attached to the flow restrictor (3), wherein the stepper motor (31) is in electronic communication with the controller (5).

The present invention also provides methods for detecting an analyte comprising: passing a mobile phase comprising the analyte to a separator (2) at a first pump flow rate; passing the mobile phase from the separator (2) to a flow restrictor (3), wherein the separator (2) is in fluid communication with the flow restrictor (3); passing the mobile phase from the flow restrictor (3) to a detector (4) at a first restrictor flow rate, wherein the detector (4) is in fluid communication with the flow restrictor (3); and decreasing the first restrictor flow rate to a second restrictor flow rate upon reaching a first detection event. The separator (2), flow restrictor (3), and detector (4) can be any of those described herein.

In some embodiments, the mobile phase is a scintillation fluid, an organic solvent, or the like. The analyte(s) can be present in the mobile phase or can be introduced into the mobile phase by a sample injector prior to being passed to the separator (2). In addition, the analyte(s) being detected can be a single analyte or a plurality of analytes. Further, the analyte can be any molecule, compound, ion, or the like whose detection is sought.

The mobile phase comprising the analyte is passed to a separator (2) at a first pump flow rate from a pump (1). The first pump rate can be from about 0.1 ml/min to about 10 ml/min, from about 0.5 ml/min to about 5 ml/min, from about 1 ml/min to about 2 ml/min, or about 1 ml/min. As used in this context, the term “about” means±5% of the value it modifies. The mobile phase is then passed from the separator (2) to a flow restrictor (3), wherein the separator (2) is in fluid communication with the flow restrictor (3), as described above.

The mobile phase is then passed from the flow restrictor (3) to a detector (4) at a first restrictor flow rate, wherein the detector (4) is in fluid communication with the flow restrictor (3), as described above. The first restrictor flow rate can be from about 0.1 ml/min to about 10 ml/min, from about 0.5 ml/min to about 5 m/min, from about 1 ml/min to about 2 ml/min, or about 1 ml/min. As used in this context, the term “about” means±5% of the value it modifies. The second restrictor flow rate is measured by a flow sensor (32) located in an appropriate position. Flow sensors can be generally located throughout the apparatus to measure particular desired flow rates.

Upon reaching a first detection event, the first restrictor flow rate is decreased to a second restrictor flow rate. In some embodiments, the second restrictor flow rate is less than about 25%, less than about 10%, less than about 1%, less than about 0.1%, or less than about 0.01% of the first restriction flow rate. As used in this context, the term “about” means±5% of the value it modifies. In some embodiments, the first detection event is a first predetermined time, detection of the beginning of a peak from the analyte by the detector (4), or a user-determined manual adjustment. The first predetermined time can be any preset time after beginning the chromatography run desired by the user. The user-determined manual adjustment can be any point during the chromatography run at which the user desires to decrease the first restrictor flow rate. The beginning of the peak from the analyte can be determined by reaching a preset threshold (such as a particular absorbance value) or by reaching a particular selected slope of, for example, the absorbance vs. time.

According to some embodiments, decreasing the first restrictor flow rate to the second restrictor flow rate upon reaching the first detection event is affected by activation of the flow restrictor (3). In some embodiments, upon reaching the first detection event, the detector (4) signals a controller (5), which is in electronic communication with the detector (4) and flow restrictor (3), as described above, whereby the controller (5) signals the flow restrictor (3) to decrease the first restrictor flow rate to the second restrictor flow rate. The controller (5) can be any controller described above. In addition, the flow restrictor (3) can be optionally attached to a stepper motor (31), as described above. Activation of the flow restrictor (3), as used herein, does not necessarily mean complete activation whereby the first restrictor flow rate is decreased to zero.

In some embodiments, in order to provide a stable low flow rate, the opening of the flow restrictor (3) can be calibrated before use based on the pressure of pump (1) and flow rate. For example, the restrictor opening (15) can be adjusted while monitoring the target pump pressure (e.g., 100 bar) with the pump flow rate set to the target slow flow rate (e.g., 5 μl/min). The target pressure is the pump pressure under normal flow mode (e.g., 1 ml/min). When the target pressure is maintained, the setting of opening (15) is calibrated. This calibrated restrictor setting then can be used for slow flow mode. However, sometimes the opening (15) might change over time. This problem is solved by on-line adjustment of opening (15) while maintaining the target pressure with the calibrated pump slow flow rate. This method effectively enables the accurate and stable target slow flow rate under slow flow mode. The advantage of this on-line adjustment is that the pump (1) can deliver a much lower flow rate comparing to its normal flow rate range. One skilled in the art can measure the actual flow rate by adjusting the flow rate settings of pump (1) to accurately calibrate the system. For example, a pump (1) with a flow rate range of 1-5000 μl/min can be calibrated and deliver 100 nl/min flowrate by turning the pump (1) on and off in pre-determined periods of duration while maintaining the pump pressure.

In some embodiments, an amount of eluant from the separator (2) is diverted to a second separator (not shown). The eluant from the separator (2) can optionally be diluted with a second mobile phase prior to diverting the eluant to the second separator. The second mobile phase can be identical to or different from the mobile phase passing into the separator (2). In some embodiments, the second separator is a 2-dimensional high pressure liquid chromatography column. In some embodiments, diversion of an amount of eluant to the second separator is initiated by the detector (4) signaling to a controller (5), which is in electronic communication with the detector (4), separator (2), and second separator, upon reaching the first detection event.

In some embodiments, the methods further comprise decreasing the first pump flow rate of the mobile phase to the separator (2) to a second pump flow rate when the first detection event is reached. In some embodiments, a pump (1) is in fluid communication with the separator (2) and wherein upon reaching the first detection event, the detector (4) signals a controller (5), which is in electronic communication with the detector (4), flow restrictor (3), and pump (1), whereby the controller (5) signals the flow restrictor (3) to decrease the first restrictor flow rate to the second restrictor flow rate, and whereby the controller (5) also signals the pump (1) to decrease the first pump flow rate to the second pump flow rate. According to some embodiments, decreasing the first restrictor flow rate of the mobile phase containing the eluant to the second restrictor flow rate upon reaching the first detection event occurs simultaneously with, or ±0 to 5 seconds, or ±0 to 3 seconds, or ±0 to 1 second of decreasing the first pump flow rate of the mobile phase to the separator (2) to the second pump flow rate.

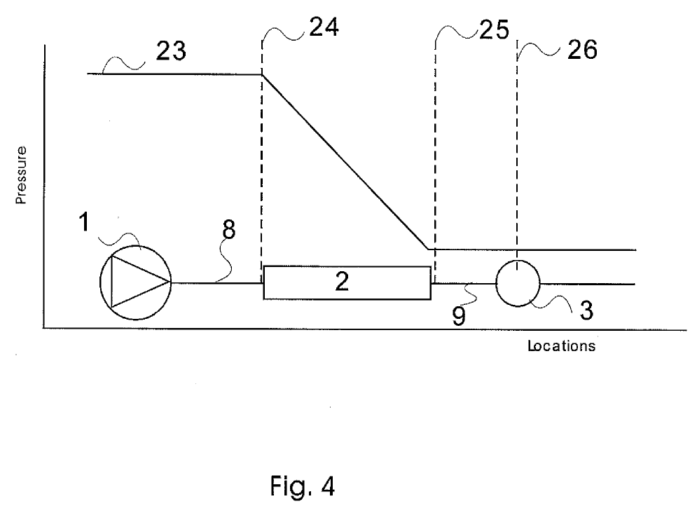

In some embodiments, the pressure in the separator (2) remains substantially steady after the flow restrictor (3) decreases the first restrictor flow rate to the second restrictor flow rate and the pump (1) decreases the first pump flow rate to the second pump flow rate. Pressure drop in the separator (2) depends on the flow rate of the system. Further, maintaining separator pressure preserves the separation of peaks inside the separator (2). FIG. 4 demonstrates the pressure drop that occurs in the separator (2) in the absence of a flow restrictor (3). For example, pressure in the system (23) drops to a lower pressure once the mobile phase reaches the inlet of the separator (24) and continues to drop until reaching the outlet of the separator (25) where it levels off through the position of the flow restrictor (26).

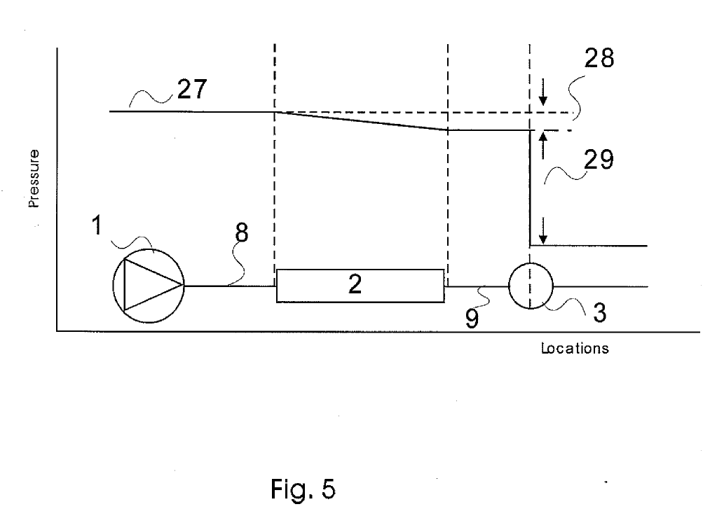

FIG. 5 illustrates the effects of the flow restrictor (3) on the pressure in the separator (2) when the first restrictor flow rate is decreased to the second restrictor flow rate. For example, pressure in the system (27) drops to a minimally lower pressure once the mobile phase reaches the inlet of the separator and continues to drop only minimally until reaching the outlet of the separator where it levels off through the position of the flow restrictor. The pressure drop (28) from the beginning of the run until the mobile phase enters the flow restrictor (3) is only minimal. The pressure drop on the flow restrictor (29), however, is much greater.

In some embodiments, after the first restrictor flow rate is decreased to the second restrictor flow rate and the first pump rate is optionally lowered to the second pump rate, the methods further comprise increasing the second restrictor flow rate back to about the first restrictor flow rate upon reaching a second detection event. As used in this context, the term “about” means less than 50% to greater than 200% of the first restrictor flow rate. For example, if the first restrictor flow rate is 1 ml/min, which was decreased to a second restrictor flow rate of 100 μl/min, then the flow rate could be increased to between 500 μl/min and 2 ml/min. In some embodiments, the second detection event is a second predetermined time, detection of the end of a peak from the analyte by the detector (4), or a user-determined manual adjustment. The second predetermined time can be any preset time after beginning the chromatography run desired by the user. The user-determined manual adjustment can be any point during the chromatography run at which the user desires to increase the second restrictor flow rate back to about the first restrictor flow rate. The end of the peak from the analyte can be determined by reaching a preset threshold (such as a particular absorbance value) or by reaching a particular selected slope of, for example, the absorbance vs. time.

In some embodiments, increasing the second restrictor flow rate back to about the first restrictor flow rate upon reaching the second detection event is affected by de-activation of the flow restrictor (3). In some embodiments, upon reaching the second detection event, the detector (4) signals a controller (5), which is in electronic communication with the detector (4) and flow restrictor (3), whereby the controller (5) signals the flow restrictor to increase the second restrictor flow rate back to about the first restrictor flow rate. The controller (5) can be any controller described above. In addition, the flow restrictor (3) can be optionally attached to a stepper motor (31), as described above. De-activation of the flow restrictor (3), as used herein, does not necessarily mean complete de-activation whereby the second restrictor flow rate is increased to a maximum flow rate.

In some embodiments, the methods further comprise increasing the second pump flow rate of the mobile phase to the separator (2) back to about the first pump flow rate. As used in this context, the term “about” means less than 50% to greater than 200% of the first pump rate. For example, if the first pump flow rate is 1 ml/min, which was decreased to a second pump flow rate of 100 μl/min, then the flow rate could be increased to between 500 μl/min and 2 ml/min. In some embodiments, a pump (1) is in fluid communication with the separator (2) and comprises the mobile phase for passing into the separator (2), and upon reaching the second detection event, the detector (4) signals a controller (5), which is in electronic communication with the detector (4), flow restrictor (3), and pump (1), whereby the controller (5) signals the flow restrictor (3) to increase the second flow restrictor flow rate back to about the first restrictor flow rate, and whereby the controller (5) also signals the pump (1) to increase the second pump flow rate back to about the first pump flow rate.

According to some embodiments, increasing the second restrictor flow rate back to about the first restrictor flow rate upon reaching the second detection event occurs simultaneously with, or ±0 to 5 seconds, or ±0 to 3 seconds, or ±0 to 1 second of increasing the second pump flow rate of the mobile phase to the separator (2) back to about the first pump flow rate.

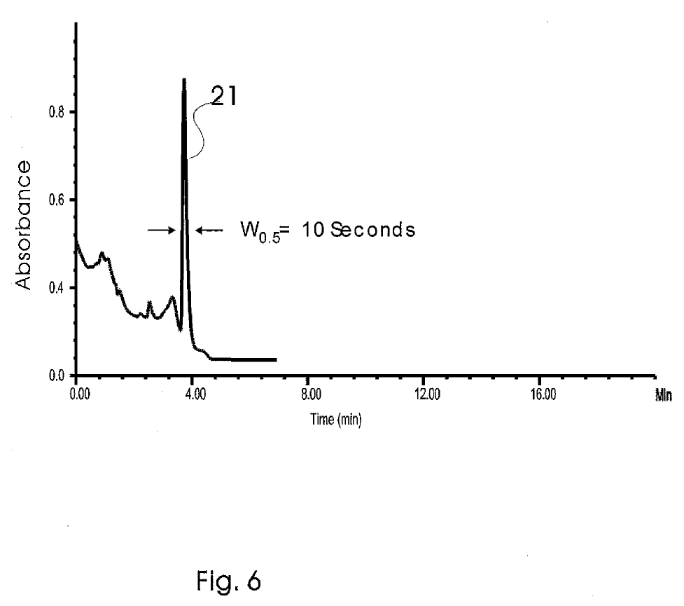

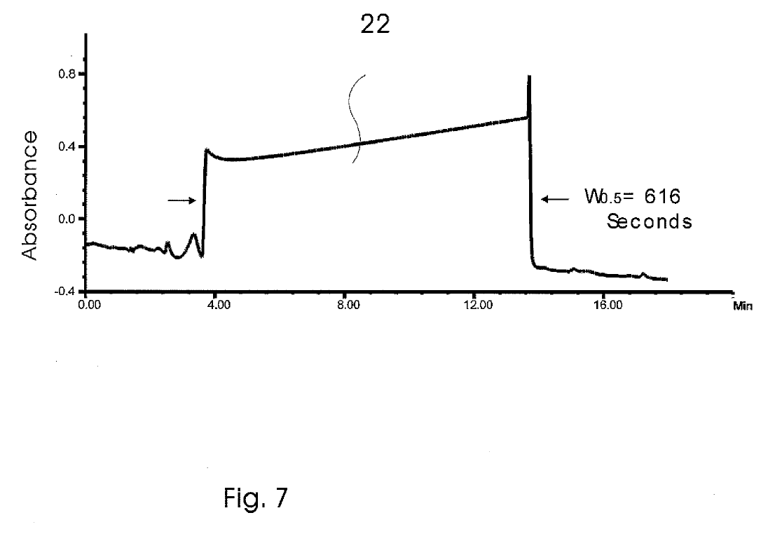

The effects of the methods described herein are demonstrated in FIGS. 6 and 7. FIG. 6 shows a chromatogram under normal flow conditions in which the analyte peak (21) was detected at the retention time of 3.73 minutes by the UV detector with a half-height peak width (W_{0.5}) of 10 seconds. The LC flow rate was 1 ml/min.

FIG. 7 shows the chromatogram where normal flow mode was performed until the pre-defined threshold is exceeded when the peak (22) is detected and the system is immediately placed under slow flow mode. The flow rate under normal flow mode was 1 ml/min and the flow rate for the slow flow mode was 5 μl/min. The peak was eluted under slow flow mode for approximately 10 minutes and turned to normal flow mode. Analyte peak (22) has a W_{0.5}=616 seconds. As the signal indicated, this peak can be eluted under slow flow mode for a much longer period of time (2000 seconds in theory based on peak volume calculation). In this example, a 60 times longer elution time was achieved for the detector where careful detection of the peak can be performed. For example, if a MS detector is attached to this system, sensitivity will increase and more time-critical experiments such as CID, MS/MS can be performed.

The embodiments of the methods described above can be combined in any manner. Thus, features from one embodiment can be combined with features from any other embodiment. For example, the embodiments described above can be combined in a manner to produce methods for detecting an analyte comprising: passing a mobile phase comprising the analyte to a separator (2) at a first pump flow rate, wherein the separator (2) is a liquid chromatography column, a high pressure liquid chromatography column, a capillary column, a nano liquid chromatography column, or a reverse phase high pressure liquid chromatography column; passing the mobile phase from the separator (2) to a flow restrictor (3), wherein the separator (2) is in fluid communication with the flow restrictor (3), and wherein the flow restrictor (3) is a needle valve; passing the mobile phase from the flow restrictor (3) to a detector (4) at a first restrictor flow rate, wherein the detector (4) is in fluid communication with the flow restrictor (3), and wherein the detector (4) is a mass spectrometer, a nuclear magnetic resonance detector, a radioactivity detector, an ultraviolet detector, or an electrochemical detector; decreasing the first restrictor flow rate to a second restrictor flow rate upon reaching a first detection event, wherein the second restriction flow rate is less than about 25% of the first restriction flow rate; decreasing the first pump flow rate of the mobile phase to the separator (2) to a second pump flow rate; increasing the second restrictor flow rate back to about the first restrictor flow rate upon reaching a second detection event; and increasing the second pump flow rate of the mobile phase to the separator (2) back to about the first pump flow rate.

The embodiments described above can be combined in a manner to produce methods for detecting an analyte comprising: passing a mobile phase comprising the analyte to a separator (2) at a first pump flow rate, wherein the separator (2) is a liquid chromatography column, a high pressure liquid chromatography column, a capillary column, a nano liquid chromatography column, or a reverse phase high pressure liquid chromatography column; passing the mobile phase from the separator (2) to a flow restrictor (3), wherein the separator (2) is in fluid communication with the flow restrictor (3), and wherein the flow restrictor (3) is a needle valve; passing the mobile phase from the flow restrictor (3) to a detector (4) at a first restrictor flow rate, wherein the detector (4) is in fluid communication with the flow restrictor (3), and wherein the detector (4) is a mass spectrometer, a nuclear magnetic resonance detector, a radioactivity detector, an ultraviolet detector, or an electrochemical detector; upon reaching a first detection event, the detector (4) signals a controller (5), which is in electronic communication with the detector (4) and flow restrictor (3), whereby the controller (5) signals the flow restrictor (3) to decrease the first restrictor flow rate to the second restrictor flow rate, wherein the second restriction flow rate is less than about 10% of the first restriction flow rate, and also upon reaching the first detection event, the detector (4) simultaneously signals the controller (5), which is also in electronic communication with a pump (1), which is in fluid communication with the separator (2), whereby the controller (5) also signals the pump (1) to decrease the first pump flow rate to the second pump flow rate, wherein the first detection event is a first predetermined time, detection of the beginning of a peak from the analyte by the detector, or a user determined manual adjustment, and wherein the controller (5) is a microprocessor and/or computer software; upon reaching a second detection event, the detector (4) signals the controller (5) whereby the controller (5) signals the flow restrictor (3) to increase the second restrictor flow rate back to about the first restrictor flow rate, and whereby the controller (5) signals the pump (1) to increase the second pump flow rate back to about the first pump flow rate, wherein the second detection event is a second predetermined time, detection of the end of a peak from the analyte by the detector (4), or a user determined manual adjustment.

It should be understood that the embodiments and drawings described herein are only some examples of the apparatus and methods described herein and are not to be construed as limiting the invention in any manner. In addition, various modifications of the invention, in addition to those described herein, will be apparent to those skilled in the art from the foregoing description. Such modifications are also intended to fall within the scope of the appended claims.

1. An apparatus comprising:
a pump;
a separator in fluid communication with the pump;
a flow restrictor in fluid communication with the separator, wherein the flow restrictor comprises only one input port and only one output port; and
a flow sensor in fluid communication with the flow restrictor.

2. A method for detecting an analyte comprising:
passing a mobile phase comprising the analyte to a separator at a first pump flow rate;
passing the mobile phase from the separator to a flow restrictor, wherein the separator is in fluid communication with the flow restrictor;
passing the mobile phase from the flow restrictor to a detector at a first restrictor flow rate, wherein the detector is in fluid communication with the flow restrictor; and
decreasing the first restrictor flow rate to a second restrictor flow rate upon reaching a first detection event.

3. The method of claim 2 further comprising:
decreasing the first pump flow rate of the mobile phase to the separator to a second pump flow rate.

4. The method of claim 3 wherein the pressure in the separator remains substantially steady after the flow restrictor decreases the first restrictor flow rate to the second restrictor flow rate and the pump decreases the first pump flow rate to the second pump flow rate.

5. The method of claim 2 further comprising:
increasing the second restrictor flow rate back to about the first restrictor flow rate upon reaching a second detection event.

6. The method of claim 3 further comprising:
increasing the second restrictor flow rate back to about the first restrictor flow rate upon reaching a second detection event.

7. The method of claim 6 further comprising:
increasing the second pump flow rate of the mobile phase to the separator back to about the first pump flow rate.

8. The method of claim 2 wherein the first detection event is a first predetermined time, detection of the beginning of a peak from the analyte by the detector, or a user determined manual adjustment.

9. The method of claim 5 wherein the second detection event is a second predetermined time, detection of the end of a peak from the analyte by the detector, or a user determined manual adjustment.

10. The method of claim 6 wherein the second detection event is a second predetermined time, detection of the end of a peak from the analyte by the detector, or a user determined manual adjustment.

11. The method of claim 2 wherein decreasing the first restrictor flow rate to the second restrictor flow rate upon reaching the first detection event is affected by activation of the flow restrictor.

12. The method of claim 5 wherein increasing the second restrictor flow rate back to about the first restrictor flow rate upon reaching the second detection event is affected by de-activation of the flow restrictor.

13. The method of claim 6 wherein increasing the second restrictor flow rate back to about the first restrictor flow rate upon reaching the second detection event is affected by de-activation of the flow restrictor.

14. The method of claim 3 wherein decreasing the first restrictor flow rate to the second restrictor flow rate upon reaching a first detection event occurs simultaneously with or within 0 to 5 seconds of decreasing the first pump flow rate of the mobile phase to the separator to the second pump flow rate.

15. The method of claim 14 wherein the pressure in the separator remains substantially steady after the flow restrictor decreases the first restrictor flow rate to the second restrictor flow rate and the pump decreases the first pump flow rate to the second pump flow rate.

16. The method of claim 2 wherein upon reaching the first detection event, the detector signals a controller, which is in electronic communication with the detector and flow restrictor, whereby the controller signals the flow restrictor to decrease the first restrictor flow rate to the second restrictor flow rate.

17. The method of claim 3 wherein a pump is in fluid communication with the separator and comprises the mobile phase for passing into the separator; and wherein upon reaching the first detection event, the detector signals a controller, which is in electronic communication with the detector, flow restrictor, and the pump, whereby the controller signals the flow restrictor to decrease the first restrictor flow rate to the second restrictor flow rate, and whereby the controller signals the pump to decrease the first pump flow rate to the second pump flow rate.

18. The method of claim 5 wherein upon reaching the second detection event, the detector signals a controller, which is in electronic communication with the detector and flow restrictor, whereby the controller signals the flow restrictor to increase the second restrictor flow rate back to about the first restrictor flow rate.

19. The method of claim 6 wherein upon reaching the second detection event, the detector signals a controller, which is in electronic communication with the detector and flow restrictor, whereby the controller signals the flow restrictor to increase the second restrictor flow rate back to about the first restrictor flow rate.

20. The method of claim 7 wherein a pump is in fluid communication with the separator and comprises the mobile phase for passing into the separator; and wherein upon reaching the second detection event, the detector signals a controller, which is in electronic communication with the detector, flow restrictor, and the pump, whereby the controller signals the flow restrictor to increase the second restrictor flow rate back to about the first restrictor flow rate, and whereby the controller signals the pump to increase the second pump flow rate back to about the first pump flow rate.

21. The method of claim 2 wherein the second restriction flow rate is less than about 25% of the first restriction flow rate.

22. The method of claim 2 wherein the second restriction flow rate is less than about 1% of the first restriction flow rate.

23. The method of claim 2 wherein the second restriction flow rate is less than about 0.01% of the first restriction flow rate.

24. The method of claim 2 wherein the separator is a liquid chromatography column, a high pressure liquid chromatography column, a capillary column, a nano liquid chromatography column, or a reverse phase high pressure liquid chromatography column, the flow restrictor is a needle valve, the detector is a mass spectrometer, a nuclear magnetic resonance detector, a radioactivity detector, an ultraviolet detector, or an electrochemical detector.

25. The method of claim 17 wherein a stepper motor is attached to the flow restrictor, wherein the stepper motor is in electronic communication with the controller, and wherein the stepper motor activates or de-activates the flow restrictor.

26. The method of claim 2 further comprising diverting an amount of eluant from the separator to a second separator.

27. The method of claim 26 further comprising diluting the eluant from the separator with a second mobile phase prior to diverting the eluant to the second separator.

28. The method of claim 26 wherein the second separator is a 2-dimensional high pressure liquid chromatography column.

29. The method of claim 26 wherein the diversion of an amount of eluant to the second separator is initiated by the detector sending a signal to a controller, which is in electronic communication with the detector, separator, and second separator, upon reaching the first detection event.

30. A method for detecting an analyte comprising:
passing a mobile phase comprising the analyte to a separator at a first pump flow rate, wherein the separator is a liquid chromatography column, a high pressure liquid chromatography column, a capillary column, a nano liquid chromatography column, or a reverse phase high pressure liquid chromatography column;
passing the mobile phase from the separator to a flow restrictor, wherein the separator is in fluid communication with the flow restrictor, and wherein the flow restrictor is a needle valve;
passing the mobile phase from the flow restrictor to a detector at a first restrictor flow rate, wherein the detector is in fluid communication with the flow restrictor, and wherein the detector is a mass spectrometer, a nuclear magnetic resonance detector, a radioactivity detector, an ultraviolet detector, or an electrochemical detector;
decreasing the first restrictor flow rate to a second restrictor flow rate upon reaching a first detection event, wherein the second restriction flow rate is less than about 25% of the first restriction flow rate;
decreasing the first pump flow rate of the mobile phase to the separator to a second pump flow rate;
increasing the second restrictor flow rate back to about the first restrictor flow rate upon reaching a second detection event; and
increasing the second pump flow rate of the mobile phase to the separator back to about the first pump flow rate.

31. A method for detecting an analyte comprising:
passing a mobile phase comprising the analyte to a separator at a first pump flow rate, wherein the separator is a liquid chromatography column, a high pressure liquid chromatography column, a capillary column, a nano liquid chromatography column, or a reverse phase high pressure liquid chromatography column;
passing the mobile phase from the separator to a flow restrictor, wherein the separator is in fluid communication with the flow restrictor, and wherein the flow restrictor is a needle valve;
passing the mobile phase from the flow restrictor to a detector at a first restrictor flow rate, wherein the detector is in fluid communication with the flow restrictor, and wherein the detector is a mass spectrometer, a nuclear magnetic resonance detector, a radioactivity detector, an ultraviolet detector, or an electrochemical detector;
upon reaching a first detection event, the detector signals a controller, which is in electronic communication with the detector and flow restrictor, whereby the controller signals the flow restrictor to decrease the first restrictor flow rate to the second restrictor flow rate, wherein the second restriction flow rate is less than about 10% of the first restriction flow rate, and also upon reaching the first detection event, the detector simultaneously signals the controller, which is also in electronic communication with a pump, which is in fluid communication with the separator, whereby the controller also signals the pump to decrease the first pump flow rate to the second pump flow rate, wherein the first detection event is a first predetermined time, detection of the beginning of a peak from the analyte by the detector, or a user determined manual adjustment, and wherein the controller is a microprocessor and/or computer software;
upon reaching a second detection event, the detector signals the controller whereby the controller signals the flow restrictor to increase the second restrictor flow rate back to about the first restrictor flow rate, and whereby the controller signals the pump to increase the second pump flow rate back to about the first pump flow rate, wherein the second detection event is a second predetermined time, detection of the end of a peak from the analyte by the detector, or a user determined manual adjustment.

32. The method of claim 2 wherein the second restrictor flow rate is measured by a flow sensor.
